(19) United States
(12) Patent Application Publication
(10) Pub. No.: US 2019/0061814 A1
(43) Pub. Date: Feb. 28, 2019

(54) TIE ROD END AND METHOD OF PRODUCING THE SAME

(71) Applicant: TOYOTA JIDOSHA KABUSHIKI KAISHA, Toyota-shi (JP)

(72) Inventor: Yuma SAIKI, Toyota-shi (JP)

(73) Assignee: TOYOTA JIDOSHA KABUSHIKI KAISHA, Toyota-shi (JP)

(21) Appl. No.: 16/044,856

(22) Filed: Jul. 25, 2018

(30) Foreign Application Priority Data
Aug. 31, 2017 (JP) 2017-167263

(51) Int. Cl. B62D 7/20; B21J 5/02

(52) U.S. Cl. CPC B62D 7/20; B21J 5/02

(57) ABSTRACT

A tie rod end of a vehicle steering apparatus, wherein a first end of the tie rod end is coupled to an axial member disposed so as to extend in a vehicle width direction and configured to move in the width direction in accordance with a steering operation, and a second end of the tie rod end is coupled to a steering knuckle holding a wheel, wherein the tie rod end includes a curved portion which is curved between the first end and the second end, the curved portion including a first-end-side portion located near to the first end, a second-end-side portion located near to the second end, and an intermediate portion located between the first-end-side portion and the second-end-side portion, and wherein a width of the curved portion in a curve direction is larger at the intermediate portion than at the first-end-side portion and the second-end-side portion.

### CROSS REFERENCE TO RELATED APPLICATION

The present application claims priority from Japanese Patent Application No. 2017-167263, which was filed on Aug. 31, 2017, the disclosure of which is herein incorporated by reference in its entirety.

### BACKGROUND

### Technical Field

The following disclosure relates to a tie rod end of a steering apparatus installed on a vehicle.

### Description of Related Art

A steering apparatus for a vehicle includes an axial member referred to as a tie rod as disclosed in Japanese Patent Application Publication No. 2010-77505, for instance. The axial member (tie rod) is disposed so as to extend in a width direction of the vehicle and moves in the width direction of the vehicle in accordance with a steering operation by a driver of the vehicle. Further, the steering apparatus includes a steering knuckle holding a wheel that is steered (turned). An end portion of the axial member or a component attached to an end portion of the axial member is typically referred to as a tie rod end. The tie rod end is coupled to the steering knuckle. In the thus configured steering apparatus, the wheel is steered via the tie rod end by the movement of the axial member.

### SUMMARY

The tie rod end is a portion or a component for transmitting a force by which the wheel is steered. Thus, the tie rod end needs to have a considerable strength. Further, it is required to prevent the tie rod end from interfering with other components and members of the vehicle. Accordingly, the present disclosure relates to a tie rod end having high utility and also relates to a method of easily producing such a tie rod end.

In one aspect of the present disclosure, a tie rod end includes a curved portion between a first end coupled to the axial member and a second end coupled to the steering knuckle, and a width of the curved portion in a curve direction is larger at an intermediate portion than at a first-end-side portion of the curved portion near to the first end and a second-end-side portion of the curved portion near to the second end, the intermediate portion being located between the first-end-side portion and the second-end-side portion.

In another aspect of the present disclosure, where a straight line connecting the first end and the second end is defined as an axis of the tie rod end and a direction of extension of the axis is defined as an axial direction, a method of producing the tie rod includes a plurality of forging steps which are successively performed and in each of which two dies are closed in a direction perpendicular to both of the axial direction and the curve direction, and wherein the plurality of forging steps are performed such that an amount by which the curved portion shifts from the axis increases with an increase in the number of times of the plurality of forging steps performed.

### ADVANTAGEOUS EFFECTS

In the case where a straight tie rod end is disposed, there may arise a problem of interference with other constituent components of the vehicle. Employment of the tie rod end according to the present disclosure obviates the problem of interference owing to the curved portion. Here, a line connecting the first end and the second end of the tie rod end is defined as an axis of the tie rod end. When the wheel is steered, a force acts on the tie rod end in an axial direction which is a direction of extension of the axis. In the tie rod end of the present disclosure, the width in the curve direction is larger at the intermediate portion of the curved portion than at the first-end-side portion and the second-end-side portion of the curved portion. Thus, in spite of provision of the curved portion, the tie rod end has an appropriate strength.

Further, according to the method of producing the tie rod end of the present disclosure, it is possible to easily form the tie rod end including the curved portion without changing a direction of closing two dies in forging, namely, without changing a direction of forging.

### FORMS OF THE INVENTION

There will be exemplified and explained various forms of an invention that is considered claimable. (The invention will be hereinafter referred to as “claimable invention” where appropriate). Each of the forms is numbered like the appended claims and depends from the other form or forms, where appropriate. This is for easier understanding of the claimable invention, and it is to be understood that combinations of constituent elements that constitute the invention are not limited to those described in the following forms. That is, it is to be understood that the claimable invention shall be construed in the light of the following description of various forms and embodiments. It is to be further understood that, as long as the claimable invention is construed in this way, any form in which one or more constituent elements is/are added to or deleted from any one of the following forms may be considered as one form of the claimable invention.

(1) A tie rod end of a steering apparatus for a vehicle,

wherein a first end of the tie rod end is coupled to an axial member which is disposed so as to extend in a width direction of the vehicle and which is configured to move in the width direction in accordance with a steering operation, and a second end of the tie rod end is coupled to a steering knuckle holding a wheel of the vehicle,

wherein the tie rod end includes a curved portion which is curved between the first end and the second end, the curved portion including a first-end-side portion located near to the first end, a second-end-side portion located near to the second end, and an intermediate portion located between the first-end-side portion and the second-end-side portion, and

wherein a width of the curved portion in a curve direction is larger at the intermediate portion than at the first-end-side portion and the second-end-side portion.

This form is a basic form of a tie rod end according to the claimable invention. Many of typical tie rod ends are shaped like straight bars. Such a straight tie rod end disposed in the vehicle steering apparatus may cause interference with other constituent components of the vehicle such as a suspension apparatus and a wheel that is steered. The present tie rod end including the curved portion obviates such interference with other constituent components of the vehicle owing to the curvature of the curved portion.

On one hand, it is desirable that the tie rod have a high strength. On the other hand, it is desirable that the tie rod end have stiffness which is low to some extent for improving a steering feeling. Here, a line connecting respective centers (cross-sectional centers) of the first end and the second end of the tie rod end is defined as an axis of the tie rod end, and a direction of extension of the axis is defined as an axial direction. The tie rod end receives a force in the axial direction when the wheel is steered. The curved portion is effective in ensuring appropriate stiffness with respect to the force.

On the contrary, the presence of the curved portion leads to a decrease in the strength of the tie rod end. In the tie rod end of this form, the width in the curve direction, in other words, a cross-sectional dimension in the curve direction, is made larger at the intermediate portion of the curved portion than at the first-end-side portion and the second-end-side portion thereof. Thus, an appropriate strength is ensured. Here, the curved direction may be defined as a direction in which the tie rod end shifts from the axis by being curved.

The “axial member” in this form may include various types of members in accordance with the structure of the steering apparatus. For instance, in a symmetrical link type steering apparatus and a center-arm type steering apparatus, a tie rod corresponds to the axial member. In a rack and pinion type steering apparatus, a rack bar on which a rack is formed corresponds to the axial member or a rack end provided at an end portion of the rack bar corresponds to the axial member. It may be also considered that a portion of the rack bar on which the rack is formed is regarded as a rack bar main boy and a combination of the rack bar main body and the rack end constitutes the rack bar. That is, while the tie rod end of this form is coupled at the first end thereof to the axial member, the tie rod end may be coupled directly to the axial member, may be coupled to the axial member via some component, or may be formed integrally with the axial member. In the rack and pinion steering apparatus, the tie rod end attached to the end portion of the rack bar or to an end portion of the rack end may be referred to as a portion of the tie rod.

(2) The tie rod end according to the form (1), wherein one of an outer portion of the curved portion located on an outer side in a curvature in the curved portion and an inner portion located on an inner side in the curvature of the curved portion has a thickness smaller than the other of the outer portion and the inner portion at least at the intermediate portion, so as to be formed as a thin portion.

The curved portion is formed so as to shift in any direction with respect to the axis indicated above. The “outer portion of the curved portion located on an outer side in a curvature of the curved portion” and the “inner portion located on an inner side in the curvature of the curved portion” in this form may be respectively referred to as a portion of the curved portion farther from the axis and a portion of the curved portion near to the axis. One of the outer and inner portions formed as the thin portion is effective for reducing the weight of the tie rod end that would be otherwise increased by an increase in the width, without lowering the strength too much. The tie rod end of this form may include the thin portion not only at the intermediate portion but also over the entire length of the curved portion. For the sake of convenience, the outer portion and the inner portion indicated above will be simply referred to as “outer portion in the curvature of the curved portion” and “inner portion in the curvature of the curved portion”.

(3) The tie rod end according to the form (2), wherein the outer portion of the curved portion located on the outer side in the curvature of the curved portion is the thin portion.

According to this form, the center of gravity in the cross-sectional shape, specifically, the center of gravity in the cross section taken along a plane perpendicular to the axis, is located in the inner portion in the curvature of the curved portion. That is, the center of gravity is located near to the axis. As later explained, in the case where the tie rod end is formed by forging of a straight blank, specifically, in the case where forging is performed by closing two dies in a direction perpendicular to both of the axial direction and the curve direction, the blank plastically flows in the curve direction. According to this form, the position of the center of gravity is near to the axis, so that an amount of the plastic flow is relatively small. That is, this form facilitates forming of the tie rod end by forging.

(4) The tie rod end according to the form (3), wherein at least the intermediate portion is shaped such that the outer portion of the curved portion located on the outer side in the curvature of the curved portion is a web and the inner portion of the curved portion located on the inner side in the curvature of the curved portion is a flange.

This form is one example of the above form in which the outer portion in the curvature of the curved portion is the thin portion. That is, in this form, at least the intermediate portion has a T-like cross-sectional shape. (The cross-sectional shape is a shape in cross section perpendicular to the axis unless otherwise specified.) This form may be modified such that the outer portion in the curvature is a web and the inner portion in the curvature is a flange not only at the intermediate portion but also over the entire length of the curved portion.

(5) The tie rod end according to any one of the forms (1) through (4), wherein the width of the curved portion in the curve direction gradually decreases toward the first end and the second end.

This form provides the tie rod end in which no steps exist in its longitudinal direction and whose width is the largest at the intermediate portion. The tie rod end of this form has a relatively high strength even though it is relatively light in weight. Further, formability in forging is good.

(6) The tie rod end according to any one of the forms (1) through (5), wherein, in a state in which the tie rod end is installed on the vehicle, the curved portion is curved so as to be convex toward a front side or a rear side of the vehicle.

When the wheel is steered, the wheel takes a posture in which a portion of the wheel on the front side of the vehicle or a portion of the wheel on the rear side of the vehicle is located on an inner side of the vehicle. The axial member described above is disposed so as to shift toward the front side or the rear side of the vehicle relative to a straight line connecting centers of rotation of right and left wheels in non-steered state. The tie rod end is also disposed so as to similarly shift. Accordingly, in the case where the wheel is largely steered, it is expected that a rim or the like of the wheel interferes with the tie rod end. This form enables such interference to be obviated. For obviating the interference between the tie rod end and the rim of the wheel or the like, the curved portion is disposed such that the curved portion is curved so as to be convex toward the rear side of the vehicle in the case where the axial member is disposed so as to shift toward the front side of the vehicle, and the curved portion is disposed such that the curved portion is curved so as to be convex toward the front side of the vehicle in the case where the axial member is disposed so as to shift toward the rear side of the vehicle.

(7) The tie rod end according to any one of the forms (1) through (6), wherein, where a straight line connecting a center of the first end and a center of the second end is defined as an axis of the tie rod end, a section of the curved portion in its longitudinal direction that is shifted from the axis by the largest amount does not overlap the axis.

The curved portion of this form is relatively largely curved. It is thus possible to effectively obviate interference with other constituent components of the vehicle such as the suspension apparatus and the wheel that is steered. Further, this form is effective for achieving the tie rod end with relatively low stiffness.

(10) A method of producing the tie rod end according to any one of the forms (1) through (7),

wherein, where a straight line connecting a center of the first end and a center of the second end is defined as an axis of the tie rod end and a direction of extension of the axis is defined as an axial direction, the method comprising a plurality of forging steps which are successively performed and in each of which two dies are closed in a direction perpendicular to both of the axial direction and the curve direction, and

wherein the plurality of forging steps are performed such that an amount by which the curved portion shifts from the axis increases with an increase in the number of times of the plurality of forging steps performed.

This form relates to a method of producing the tie rod ends in various forms of the claimable invention, and the method includes a plurality of forging steps. Most of the tie rod ends are made of steel and typically formed by die forging. The tie rod ends in the above forms include the curved portion. Accordingly, the curved portion may be easily formed by closing the two dies in the curve direction of the curved portion. In view of favorable formation of the entirety of the tie rod end, however, it is desirable to close the two dies in a direction perpendicular to both of the curve direction and the axial direction. For favorably forming the tie rod end whose curved portion is curved so as to be convex toward the front side or toward the rear side, it is desirable that an attachment portion for a ball joint be concurrently formed at the second end in forging. Accordingly, in consideration of forging burrs, the two dies need to be closed in the direction perpendicular to both of the curve direction and the axial direction. According to the producing method of this form, the curved portion can be formed by performing, a plurality of times, the forging step in which the two dies are closed in the direction perpendicular to both of the curve direction and the axial direction. It is thus not required to change an orientation of an intermediate article between any of successively performed forging steps, namely, throughout successively performed forging steps, enabling easy production of the tie rod ends described in the above forms.

In this form, the shift amount of the curved portion increases as a result of a plastic flow of the material. That is, the curved amount increases with an increase in the number of times of the forging steps performed. In view of this, the amount of the plastic flow of the material can be decreased by making the thickness of the outer portion in the curvature of the curved portion (the dimension in the direction perpendicular to both of the axial direction and the curve direction) smaller than the thickness of the inner portion in the curvature of the curved portion, namely, by forming the outer portion in the curvature of the curved portion as the thin portion. In this sense, this form is suitable for producing the tie rod end in which the outer portion in the curvature of the curved portion is the thin portion.

### BRIEF DESCRIPTION OF THE DRAWINGS

The objects, features, advantages, and technical and industrial significance of the present disclosure will be better understood by reading the following detailed description of an embodiment, when considered in connection with the accompanying drawings, in which:

FIG. 1 is a perspective view showing a state in which a tie rod end according to one embodiment is disposed in a steering apparatus of a vehicle;

FIG. 2 is a plan view of the tie rod end of the embodiment and includes cross-sectional views of the tie rod end; and

FIGS. 3A, 3B and 3C are schematic views for explaining forging steps performed in a method of producing the tie rod end of the embodiment.

### DETAILED DESCRIPTION OF THE EMBODIMENT

Referring to the drawings, there will be explained below in detail a tie rod end according to one embodiment of the claimable invention and a method of producing the tie rod end. It is to be understood that the claimable invention is not limited to the details of the following embodiment but may be embodied based on the forms described in Forms of the Invention and may be changed and modified based on the knowledge of those skilled in the art.

[A] Vehicle Steering Apparatus including Tie Rod End

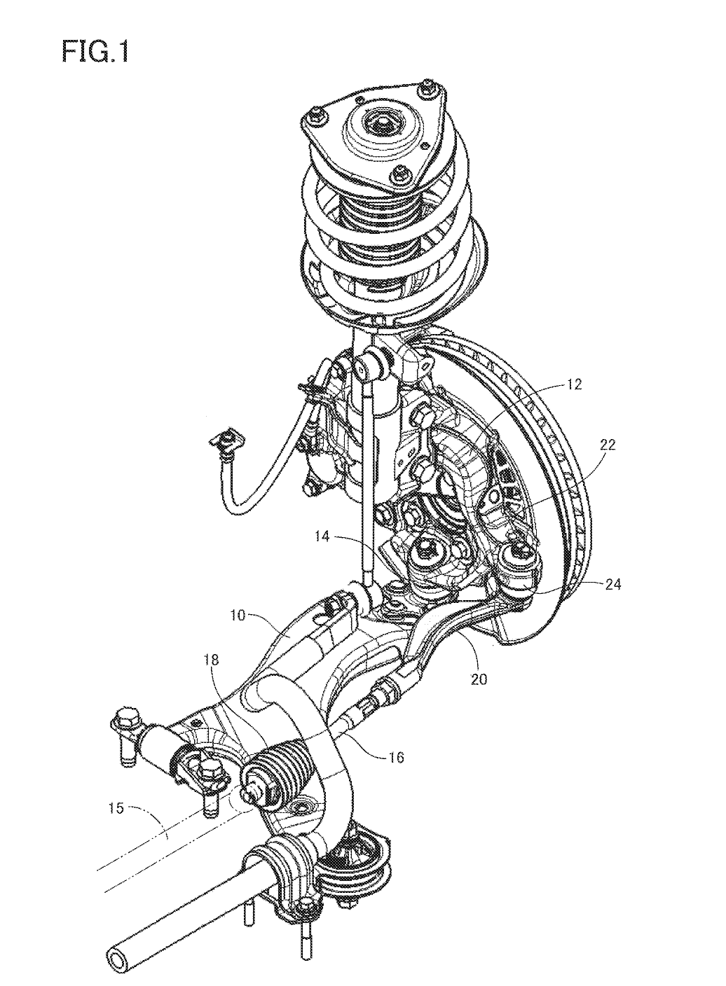

A tie rod end according to the present embodiment is employed as a constituent component in a vehicle steering apparatus that is partly illustrated in FIG. 1. The steering apparatus is configured to steer (turn) a wheel supported by a strut type suspension apparatus. While the wheel is not illustrated, the wheel is rotatably supported by a steering knuckle 12 supported by a suspension lower arm 10. The steering knuckle 12 is supported by the lower arm 10 via a ball joint 14 so as to be pivotable about a king pin axis. In FIG. 1, a principal part of a suspension apparatus for a front right wheel of the vehicle and a part of the steering apparatus are illustrated.

The steering apparatus is of a rack and pinion type and includes therein a gear box in which is disposed a rack bar 15 on which a rack is formed. In FIG. 1, the gear box is not illustrated, and the rack bar 15 is indicated by the long dashed double-short dashed line. FIG. 1 further illustrates a boot 18 disposed at an end portion of the gear box and a rack end 16 which is coupled to the rack bar 15 via a ball joint and which extends from the gear box. The rack bar 15 and the rack end 16 function as an axial member which is disposed so as to extend in a width direction of the vehicle and which moves in the width direction of the vehicle in accordance with a steering operation. It is noted that only the rack bar 15 may be regarded as the axial member or only the rack end 16 coupled to an end portion of the rack bar 15 may be regarded as the axial member.

A tie rod end 20 of the present embodiment is disposed so as to connect the rack end 16 and the steering knuckle 12. Specifically, an end portion of the rack end 16 is externally threaded. A first end of the tie rod end 20 (one of opposite ends of the tie rod end 20 nearer to a center of the body of the vehicle in the vehicle width direction) is coupled to and threadedly engaged with the externally threaded end portion of the rack end 16. The steering knuckle 12 includes a knuckle arm 22 extending from a main body thereof. A second end of the tie rod end 20 (the other of the opposite ends of the tie rod end 20 nearer to an outer portion of the body of the vehicle in the vehicle width direction) is coupled to a distal end portion of the knuckle arm 22 via a ball joint 24.

The gear box, namely, the rack bar 15, is disposed so as to shift toward a rear side of the vehicle with respect to a straight line connecting centers of rotation of the right and left wheels, namely, with respect to a wheel axis. Similarly, the rack end 16 and the tie rod end 20 are disposed so as to shift toward the rear side of the vehicle.

### [B] Structure of Tie Rod End

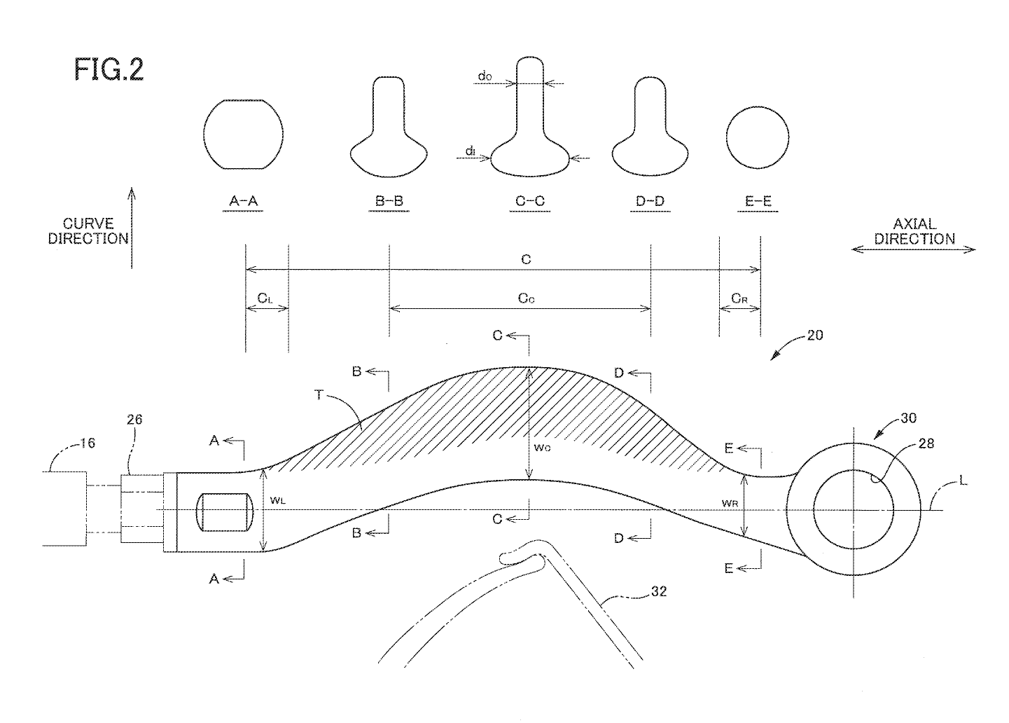

FIG. 2 is a plan view of the tie rod end 20 according to the present embodiment. FIG. 2 also shows cross sections of the tie rod end 20 at five locations in the plan view which are spaced apart from each other in a longitudinal direction of the tie rod end 20. As shown in FIG. 2, the present tie rod end 20 has, at its first end (i.e., at a left end of the tie rod end 20 in FIG. 2), an internally threaded bore with which the externally threaded end portion of the rack end 16 is engaged. Thus, the tie rod end 20 is fixed at the first end thereof to the rack end 16 by a lock nut 26. Further, the tie rod end 20 has, at its second end (i.e., at a right end of the tie rod end 20 in FIG. 2), a through-hole 28 in which a stud of the ball joint 24 is fitted. The second end of the tie rod end 20 is formed as an attachment portion 30. Here, a straight line connecting a center of the first end and a center of the second end, specifically, a straight line connecting respective cross-sectional centers of the first end and the second end (a center of the through-hole 28 for the second end) is defined as an axis L of the tie rod end 20. The tie rod end 20 includes a curved portion C which is curved with respect to the axis L between the first end and the second end.

When the wheel 32 is largely steered as indicated in the long dashed double-short dashed line in FIG. 2, specifically, when the right wheel 32 is largely steered rightward, a part of the wheel 32 (e.g., a rim of the wheel) may interfere with the tie rod end 20. The curved portion C is curved so as to be convex toward the front side of the vehicle, namely, the curved portion C is curved such that a curve direction is a forward direction. Thus, the curved portion C is effective for obviating the interference. In the present tie rod end 20, the curved portion C is curved such that a section thereof in the longitudinal direction that is shifted from the axis L by the largest amount does not overlap the axis L. In other words, at the section of the curved portion C that is shifted from the axis L by the largest amount, the axis L is spaced apart form the tie rod end 20.

It is noted that, in the case where the tie rod end is disposed so as to be shifted toward the front side of the vehicle with respect to the wheel axis, the tie rod end is configured such that the curve direction of its curved portion is a rearward direction, namely, the tie rod end is configured to have the curved portion that is curved convex toward the rear side of the vehicle, so that the interference with the wheel can be obviated. It is noted that the curved portion is effective for obviating interference with not only the wheel but also constituent components of a suspension apparatus.

The curved portion C is effective for lowering the stiffness of the tie rod end 20. In a steering operation, the tie rod end 20 receives a load in a direction of extension of the axis L (hereinafter referred to as “axial direction” where appropriate). The presence of the curved portion C provides a cushioning function with respect to the load. That is, the stiffness of the curved portion C is appropriately lowered, thereby improving the steering feeling.

On the other hand, the presence of the curved portion C leads to a decrease in the strength of the tie rod end 20 with respect to the load in the axial direction. Thus, in the tie rod end 20, a width w of the curved portion C in the curve direction is made larger. Here, a portion of the curved portion C located near to the first end is referred to as a first-end-side portion C_{L}, a portion of the curved portion C located near to the second end is referred to as a second-end-side portion C_{R}, and a portion intermediate between these two portions C_{L}, C_{R} is referred to as an intermediate portion C_{c}. In the present tie rod 20, a width wₑ of the intermediate portion C_{C} is larger than a width w_{L} of the first-end-side portion C_{L} and a width w_{R} of the second-end-side portion C_{R}. Further, the width w is the largest at a central portion of the intermediate portion C_{C} in the axial direction, and the width w gradually decreases toward the first end and the second end of the tie rod end 20. In this configuration, the width w continuously and gradually changes, so that no steps exist in the longitudinal direction of the tie rod end 20. Thus, the strength of the tie rod end 20 is effectively enhanced.

The increase in the strength of the tie rod end 20 by increasing the width of the curved portion leads to an increase in the weight of the tie rod end 20. In the present tie rod end 20, therefore, a thickness d_{O} of an outer portion of the curved portion C located on an outer side in a curvature of the curved portion C (i.e., outer portion in the curvature of the curved portion C) is made smaller than a thickness d_{I} of an inner portion of the curvature of the curved portion C located on an inner side in the curvature of the curved portion C (i.e., inner portion in the curvature of the curved portion C) over an entire length of the curved portion C, as shown in the cross-sectional views in FIG. 2. That is, a hatched portion in the plan view in FIG. 2 is formed as a thin portion T. Thus, the tie rod end 20 has, at least at the intermediate portion C_{C}, a T-like cross sectional shape taken along a plane perpendicular to the axial direction. In other words, the tie rod end 20 is configured such that, at least at the intermediate portion C_{C}, the outer portion in the curvature of the curved portion C functions as a web and the inner portion in the curvature of the curved portion C functions as a flange. It is noted that the curved portion C has a vertically symmetric cross-sectional shape. Thus, the bending strength and the stiffness of the tie rod end 20 in the up-down direction are uniform. In other words, the bending strength and the stiffness of the tie rod end 20 are the same in the upward direction and the downward direction.

Like the width w of the curved portion C, a width of the thin portion T in the curve direction is the largest at a central portion thereof in the axial direction of the intermediate portion C_{C}, and the width of the thin portion T gradually decreases toward the first end and the second end of the tie rod end 20. In short, it may be considered that the width of the curved portion C changes generally in accordance with a change in the width of the thin portion T. As later explained, the tie rod end 20 of the present embodiment is formed by forging, and a cross-sectional area of the curved portion C is substantially the same over the entire length of the curved portion C.

### [C] Method of Producing Tie Rod End

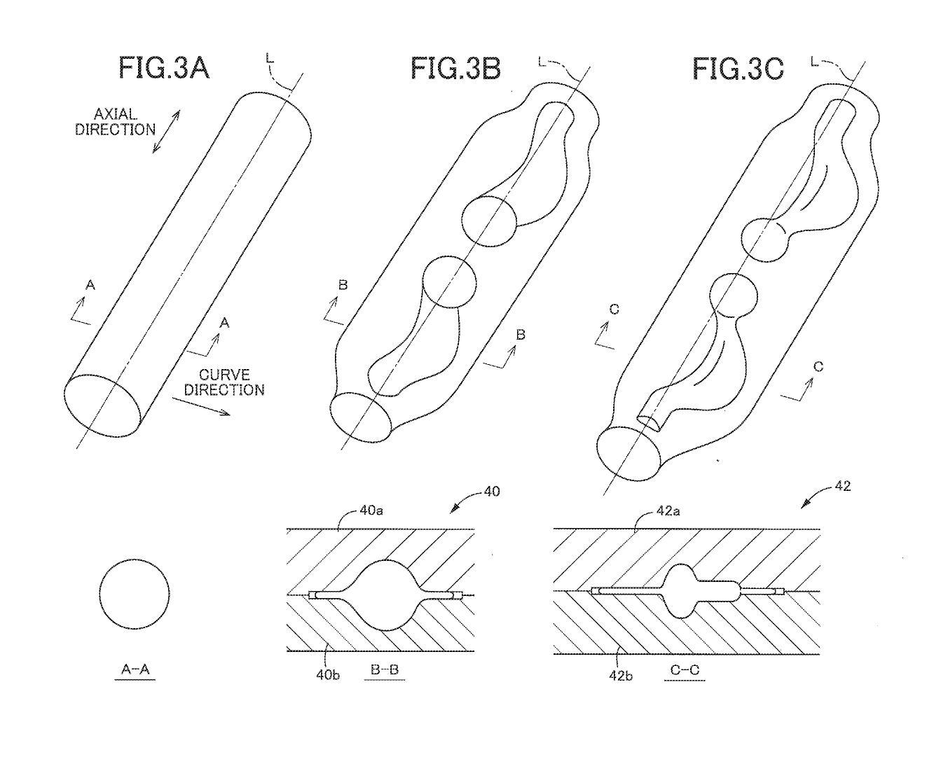

As shown in FIG. 3, the tie rod end 20 according to the present embodiment is formed by performing a thermal forging step a plurality of times. FIG. 3 schematically shows a case in which the tie rod end 20 is formed by performing the thermal forging step two times. FIG. 3A shows a blank. The blank is a round bar formed of steel and having a circular shape in cross section. FIG. 3B includes a perspective view of an article after a first forging step has been performed and a cross-sectional view of a portion of the article corresponding to the intermediate portion of the curved portion. FIG. 3C includes a perspective view of an article after a second forging step has been performed and a cross-sectional view of a portion of the article corresponding to the intermediate portion of the curved portion. In the cross-sectional views of FIGS. 3B and FIG. 3C, die sets 40, 42 used in the respective first and second forging steps are also shown in a state in which two dies of each die set are closed. While, in the present producing method, two articles are formed from one blank in each forging step, the method may be modified otherwise.

The die set 40 is constituted by an upper die 40a and a lower die 40b, and the die set 42 is constituted by an upper die 42a and a lower die 42b. A cavity is formed when the upper die 40a, 42a and the lower die 40b, 42b are closed. In each forging step, the blank is forged into a shape corresponding to the cavity while the material plastically flows. In each of the plurality of forging steps of the present method, a direction of closing the dies of the die set 40, 42, namely, in a die closing direction, coincides with the up-down direction. In other words, in all of the forging steps of the present method, the dies are closed in the same direction, namely, a direction perpendicular to both of the axial direction and the curve direction. Thus, the posture, i.e., the orientation, of the article is not changed between any of the successively performed forging steps, namely, throughout the successively performed forging steps, so that the forging steps can be easily performed.

As apparent from FIG. 3, every time the forging step is performed, the portion of the article corresponding to the curved portion moves in the curve direction while the material plastically flows. In other words, the plurality of forging steps are performed such that an amount by which the curved portion shifts from the axis L increases with an increase in the number of times of the forging steps performed. As explained above, the tie rod end 20 of the present embodiment has the thin portion T at the outer portion in the curvature of the curved portion C. Accordingly, an amount of the plastic flow of the material is smaller in the present tie rod end 20 having the thus formed thin portion T, as compared with a tie rod end having the thin portion at the inner portion in the curvature of the curved portion C. This contributes to facilitation of the forging steps and reduction in the number of the forging steps.

After the plurality of forging steps have been performed, forging burrs are removed by cutting. Further, the first end is processed to form the internally threaded bore, and the attachment portion 30 at the second end is processed to bore the through-hole 28. Thus, the tie rod end 20 is obtained.

What is claimed is:

1. A tie rod end of a steering apparatus for a vehicle,
wherein a first end of the tie rod end is coupled to an axial member which is disposed so as to extend in a width direction of the vehicle and which is configured to move in the width direction in accordance with a steering operation, and a second end of the tie rod end is coupled to a steering knuckle holding a wheel of the vehicle,
wherein the tie rod end includes a curved portion which is curved between the first end and the second end, the curved portion including a first-end-side portion located near to the first end, a second-end-side portion located near to the second end, and an intermediate portion located between the first-end-side portion and the second-end-side portion, and
wherein a width of the curved portion in a curve direction is larger at the intermediate portion than at the first-end-side portion and the second-end-side portion.

2. The tie rod end according to claim 1, wherein one of an outer portion of the curved portion located on an outer side in a curvature of the curved portion and an inner portion located on an inner side in the curvature of the curved portion has a thickness smaller than the other of the outer portion and the inner portion at least at the intermediate portion, so as to be formed as a thin portion.

3. The tie rod end according to claim 2, wherein the outer portion of the curved portion located on the outer side in the curvature of the curved portion is the thin portion.

4. The tie rod end according to claim 3, wherein at least the intermediate portion is shaped such that the outer portion of the curved portion located on the outer side in the curvature of the curved portion is a web and the inner portion of the curved portion located on the inner side in the curvature of the curved portion is a flange.

5. The tie rod end according to claim 1, wherein the width of the curved portion in the curve direction gradually decreases toward the first end and the second end.

6. The tie rod end according to claim 1, wherein, in a state in which the tie rod end is installed on the vehicle, the curved portion is curved so as to be convex toward a front side or a rear side of the vehicle.

7. The tie rod end according to claim 1, wherein, where a straight line connecting a center of the first end and a center of the second end is defined as an axis of the tie rod end, a section of the curved portion in its longitudinal direction that is shifted from the axis by the largest amount does not overlap the axis.

8. A method of producing the tie rod end defined in claim 1,
wherein, where a straight line connecting a center of the first end and a center of the second end is defined as an axis of the tie rod end and a direction of extension of the axis is defined as an axial direction, the method comprising a plurality of forging steps which are successively performed and in each of which two dies are closed in a direction perpendicular to both of the axial direction and the curve direction, and
wherein the plurality of forging steps are performed such that an amount by which the curved portion shifts from the axis increases with an increase in the number of times of the plurality of forging steps performed.
